(19) United States
(12) Patent Application Publication
(10) Pub. No.: US 2014/0366960 A1
(43) Pub. Date: Dec. 18, 2014

(54) Multi-functional valve device for expelling humidity and saturated steam for building structures

(71) Applicant: Michele Caboni, Oristano (IT)

(72) Inventor: Michele Caboni, Oristano (IT)

(21) Appl. No.: 14/369,759

(22) PCT Filed: Dec. 31, 2012
(86) PCT No.: PCT/IT2012/000408

§ 371 Date: Jun. 30, 2014

(30) Foreign Application Priority Data
Dec. 31, 2011 (IT) TO2011A0011251

(51) Int. Cl. F24F 13/22; F16K 24/04; F16K 15/04

(52) U.S. Cl. CPC F24F 13/22; F16K 15/04; F16K 24/04; F24F 2013/221
USPC 137/360

(57) ABSTRACT

Multi-functional valve device comprising: a first holding element equipped with a first hollow duct for communicating with outside the device; a second holding element operatively coupled with the first holding element and equipped with a containing seat, the second holding element equipped with a second hollow duct for communicating with outside the device; and an opening/closing element of the device, the opening/closing element being adapted to assume a closing position of the device in which it is in contact with the first holding element closing, the first hollow duct, the opening/closing element being adapted to also assume an opening position of the device in which it is not in contact with the first holding element and communicates the first hollow duct and the second hollow duct.

### FIELD OF THE INVENTION

The present invention is applied to the field of multifunctional valves devices. Specifically, those valves are employed for use in building structures including all components such as doors and windows into frame and into pillars and foundations e.g in all their components subject to condensation inside for moisture.

It should be pointed out that the present invention of the multi-function valve device does not exist and has never been known in the state of the prior art for these multiple applications and exclusive summarily and not exhaustively above for brevity.

### BACKGROUND

Valves for regulation of the fluid passage are very common devices in the state of the art. Among the kinds of valves, we can mention ball valves, valves with elongated internal element and others.

In general, valves are used to regulate the flow of different kinds of fluids, since that highly viscous as oil, until that of low viscosity as air. The design of construction of a valve depends on the nature of fluid that will be drained and of the pressure difference that must be applied for this working.

Document U.S. Pat. No. 2,682,281 describes a ball valve that works according to the moving of a piston of an oil pump. The internal ball described is made of a flexible material that deforms the ball when it is under pressure. In the present invention, it is described a valve for low viscosity fluids, as air and humidity which movement does not demand a high pressure difference, but a small one. The internal ball of the present invention is not deformable and it is not an essential condition for this working.

Document U.S. Pat. No. 3,799,186 describes a ball valve that works under vacuum and comprises a ball that has an internal diameter higher than the internal diameter of the valve. The ball valve of the present invention does not need to operate under vacuum. Also, the ball of the present invention does not comprise an internal diameter higher than the internal diameter of the valve, but a smaller diameter.

Document U.S. Pat. No. 5,117,861 discloses a ball valve that comprises a semi-spherical structure with ribs that works under a downhole rod pump. The valve of the present invention does not need to operate under vacuum, but a small pressure difference is enough for this working.

Document U.S. Pat. No. 5,785,083 discloses a check valve for a refrigerant line that comprises an internal ball. Its working is dependent of a high flow of fluid that displace the ball for the open position of the valve or for the close position of the valve. The valve of the present invention is a valve for the control of very low fluid flow as air and humidity.

Document WO 9839589 discloses a valve for dialysis that comprises an elongated internal member and allows the fluid flow in just one direction. The valve of the present invention allows the fluid flow in both directions and works under very small pressure difference.

The document EP 1113205 discloses a valve that comprises an elongated internal element with a spring. The working of the valve depends on the compressing of the spring. The valve of the present invention does not comprise a spring, but an internal ball.

The present invention relates to a multi-functional valve device for expelling humidity and saturated steam for building structures and an innovative technology applied to all types of building structures including all components such as doors and windows in all their components subject to condensation inside for moisture. Such device removes the note risks of condensation inside conventional envelope building, foundation beams, walls, floors and structures, coated with thermal coatings (also l conventional systems), without application limits on multiple thermo-acoustic covers for doors or windows, or can be also integrated on various types of frames, windows, doors, thermal caissons and thermal coatings.

The check multifunctional valves with ball-type shutter, even if known in hydraulics, according to the knowledge of the Applicant, has never been used nor is known in the building industry in general. Such type of multifunctional valves is extremely reliable, when it is positioned both vertically, and horizontally, due to its construction simplicity and to the absence of mechanisms.

Its operating principle is based on the free movement of the “ball” inside the valve body, and on the particular design of the valve body with thermal materials (so that the temperature of the passing fluid is not subjected to strong variations). Moreover, the design of the ball drive and of the delivery duct guarantees a completely open passage, free of cloggings or asperities, that otherwise could stop every type of outflow, both of steam, and of humidity or water.

Due to the free passage that is created, load losses are very low. The valve ball has a low inertia and therefore the opening pressure of the check valve is about half the opening pressure of a known valve, for example of the clapet type; the duct opening position is obtained without using springs or other mechanical means.

To obtain both a perfect seal, and a silent closing, the ball is made of phenolic resin or is coated with nitryl rubber resistant to clean, soft or sea water, to flowing or rain water, even with hydrocarbon residuals. The extreme conceptual simplicity of the valve makes it of a very long life and free from maintenance.

As is known, the realization of structures-building envelopes in all its partitions; such as foundations, walls, floors, roofs, doors, windows and frames, with thermoregulation functions, which have high performance characteristics and at the same time a good breathability is always a very sensitive issue in civil and industrial in the world.

Another very sensitive issue is to rehabilitate also the structures incorporating such as doors and windows, etc. that can be healed in less time.

A further object to provide a device in multi-function valve for expulsion of moisture and saturated vapor consists of lightweight thermal materials to facilitate transportation and installation, as well as its functionality over time.

The present inventive multi-function valve device for expulsion of moisture and saturated steam, for its particular constructive characteristics, is capable of ensuring the greatest assurances standards of reliability and safety over time.

The inventive valve device finds wide application in various fields of construction such as, for example, and without limitation, for any type of frame of windows or doors, wood, aluminum, steel or the like; for connectors spacers of any material; in the cavities of building envelopes in general, made of brick or other conventional materials, and coated with thermal coat (External Thermal Insulation Composite Systems in the rule European Association for ETICS (EAE)).

As said, the inventive device has the function to evacuate moisture, the saturated steam and interstitial condensation that are created in any building structure and/or building envelope, is monolithic, is hollow, solving the so-called “sick building syndrome”, previously known unsolved problem.

The inventive valve arrangement is based on the concept of enclosure, such as dynamic and interactive element of a complex energy system and hygrometric which, via multiple multifunction valves integrated or applied subsequently, regulates the operation of the building envelope and characterizes functionality, offering them an exclusive living comfort in all weather conditions, also very adverse.

Legislation and Technical Regulations reference for such a device is the UNI EN ISO 13788:2003, Performance hygrometric components and building elements—Internal surface temperature to avoid critical surface humidity and interstitial condensation—Calculation, Jan. 6, 2003.

To better understand the operation of the inventive device, we will discuss below the phenomena that it goes to counteract. In particular, as regards the formation of condensation in the wall of a building and/or in the various partitions of the building structure, the primary requirement in order to maintain the performance of the building envelope is to avoid the risk of formation and accumulation of condensation, so that the duration and the integrity of the building elements are not compromised, from the point of view both thermal, both because of the known structural deterioration.

Exclusive advantage of the multi-function valves of the invention reduce manifold size, number of ports, and machining costs, while increasing flow passage efficiency.

The system of multi-function valves of the invention incorporate two or more functions into a single valve, allowing for the design of a lighter, more compact valve package. The result is a more responsive envelope building performance and a more efficient use of available horsepower also.
Directional valves with isolated load-sense checks
valves with internal flow checks
with Integrated pressure relief
Proportional flow controls with integrated pressure compensation
Logic elements with built-in relief
Logic elements with flow regulation
Flow controls with adjustable pressure relief

The condensation can be of two types:
Surface condensation, when it affects the inner surface of the walls, due to the achievement of high values of relative humidity of indoor air, which creates in the vicinity of the corners of the walls and all partitions and closures transparent specimen (windows, doors) that make up the entire building envelope, the appearance of condensation;
Interstitial condensation when, inside the wall, inside in the envelope building, creating the conditions of temperature and pressure such as to achieve the conditions of dew.

The damage caused by the formation of condensation in the foundation beams, walls, floors, roofs and/or in the building structure inside in the envelope building cause:

A decay of the performance characteristics of the walls, with consequent reduction of the degree of insulation of the wall due to moisture that there is contained;

A deterioration in the quality of life and comfort of the inside rooms bounded by these walls, building structure and all partitions and closures transparent specimen (windows doors) that make up the entire building envelope;

The appearance, on the surfaces of wall and on all partitions that make up building envelope, of more mold and efflorescence in the inside and in surface, with the consequent damaging of the finishing thermal coats interior and exterior of the walls and/or building envelope, such as plasterboard, plaster, etc.

The verification of the formation of condensation inside of each wall and on all partitions that make up building envelope can be determined using the Glaser diagram, which is the graphical method through which, once known the temperature and humidity outside and inside in all partition the temperature, the pressure and the thermal characteristics relating to the individual layers that make up the wall and in the entire building envelope, they build the curve of the partial pressures and the curve relative to the saturation pressures, verifying the presence of points of intersection between the two curves.

Where there are points of intersection, this means that in those points will occur conditions of temperature and pressure such as to bring the air to a state of saturation, and consequently in here points you will have more condensation, and of course advantageously and exclusively problem is solved precisely into the building structure and all partitions and closures transparent specimen (windows doors) that make up the entire building envelope by the application of the device to multi-function valve of the invention.

The condensate is formed in this way. The air contained in a given environment may contain a certain amount of water, in the form of water vapor in suspension. The amount of water vapor that may be contained in the air depends on two variables: temperature and pressure. This means that, the air may be contain a maximum amount of water for each value of temperature and pressure and that, once this limit is reached; it has a state of saturation of the air. This saturation implies that, for each increment of a quantity of steam in addition to the maximum limit value of the content, there is a precipitation of the steam in the form of condensate, for which it is obvious and necessary to apply multiple valve devices of the invention for the expulsion of moisture and saturated steam towards the outside.

It is clear that, in conditions of constant pressure, with an increase in air temperature corresponds to an increase of the amount of vapor that may be contained in it. Consequently, the lower the temperature, the lower the quantity of steam the air can hold.

Under normal conditions the air is not saturated, but contains a certain quantity of steam (g/kg) less than the value that would correspond to a situation of air saturation. This relationship between the weight of the vapor contained in the air and the weight of the vapor contained in the same saturated air is said “relative humidity”, which is expressed as a percentage of absolute humidity. A value of 80% of relative humidity in the air, therefore, will be up to indicate that it contains 80% of the maximum quantity of water vapor that can be contained at that temperature. It has condensation when in an environment, in the presence of a certain relative humidity, the temperature decreases up to reach the saturation value, with the consequent precipitation of the vapor from the gaseous to the liquid (condensation), other condition in it becomes necessary to use the device of the invention for the expulsion of the condensate to the outside.

The “dew point” or “dew point temperature” indicates the temperature of the air, at which there will be the formation of condensate and then water. The considerations made so far, assuming applies to keep constant one of the two variables, for example the pressure that is created naturally, by varying the temperature and vice versa (i.e. even when the temperature is kept constant, by varying the pressure). Consequently that define the “partial pressure”, that is the pressure at which the steam contained in the air, at a given temperature, and “saturation pressure”, the pressure value corresponding to a condition of saturation of the air at a given temperature. The relative humidity expresses the ratio between the relative pressure and the saturation expressed as a percentage:

Ur=Pr/Ps(in %)

The verification of the condensation of the walls, into the building structure and all partitions and closures transparent specimen (windows doors) that make up the entire building envelope by the application of the device to multi-function valve of the invention. Structure preferably takes place through the so-called method of Glaser. The phenomenon of the formation of condensation on the walls as low in the corners and then spread across the surface of the building structure is created when you reach high values of relative humidity of indoor air of ‘building envelope’, thus determining the conditions for the formation of dew on the inner face of the walls and all partitions and closures transparent specimen (windows doors) that make up the entire building envelope. The condensation can also affect the inside of the wall and in all partitions building structure, e.g when within the layers that compose it, occurring conditions of temperature and pressure such as to induce the condensation of water vapor, other negative condition in which it becomes necessary to use the device inventive for the expulsion of water vapor.

Whereas the water vapor present in an environment tends to move from an area in which the vapor pressure is higher to another in which this pressure is lower, a wall that divides two environments places in different temperature and pressure will crossed by a flow of steam, that passing through the various layers of the wall will meet an obvious resistance. This resistance will be directly proportional to the thickness of the wall and of all partitions of building structure and to the characteristics of impermeability of the material of which it is composed, and therefore the value of D, a value that takes the name of “coefficient of resistance to the passage of steam”, and indicates the resistance to the passage the vapor of a certain material compared to that of air at the same temperature and pressure.

Another parameter useful for studying the phenomenon of condensation is the “coefficient of conductivity vapor barrier” or “permeability”, indicated by M, that measures the amount of steam (kg) which crosses the thickness of 1 square meter for a difference unitary pressure.

The coefficients of resistance to the passage of steam and permeability are a feature of many building materials and are related to the density of the materials themselves. They can be obtained from appropriate tables contained in the Statement rule European Community —ASTM international standards. The process by which, by relating the parameters relevant to the characteristics of the materials and the physical parameters of the layers that make up the wall and/or of all partitions of the building structure, it leads to the tracking of a diagram for the verification of the condensate in the wall, takes the procedure name Glaser. The diagram Glaser allows dimensioning the wall, both as concerns the thickness of the layers, both as regards the choice of materials that compose it, according to the characteristics of permeability of the same. The hygrometric parameters for the individual layers of the wall that are needed are:
Temperature within each layer;
Partial pressure of each layer;
Saturation pressure at various temperatures;
Resistance to water vapor of the individual layers.

Once these parameters are known, the relative diagram is built, consisting of a curve of saturation pressures and a curve of partial pressures. Comparing the curve of the partial pressures with the curve of the saturation pressures within the various layers of the wall, there may be cases:
the two curves have no points of intersection, and thus there is no danger of condensation;
the two curves have a point of tangency: in this case we have verified the conditions for the formation of condensate in a point and then simply a decrease in temperature or an increase in the relative pressure to cause the appearance of dew: even in this condition becomes obvious and essential to use the inventive device to multifunctional valve for expelling moisture;
the two curves have more points of intersection: in this case the section between the start point and the end point of the area of hypothetical intersection represents the portion of the masonry in which there is the formation of condensate, other situation that requires the use of the inventive device to multifunctional valve for the expulsion of moisture.

There are different reasons why the humidity can penetrate the walls creating the effects already discussed in other sections. It is important to recognize which are to implement the correct intervention and solve in this way the problem permanently and advantageously with the use of the inventive device to multifunctional valve in quantities necessary for the expulsion of humidity.

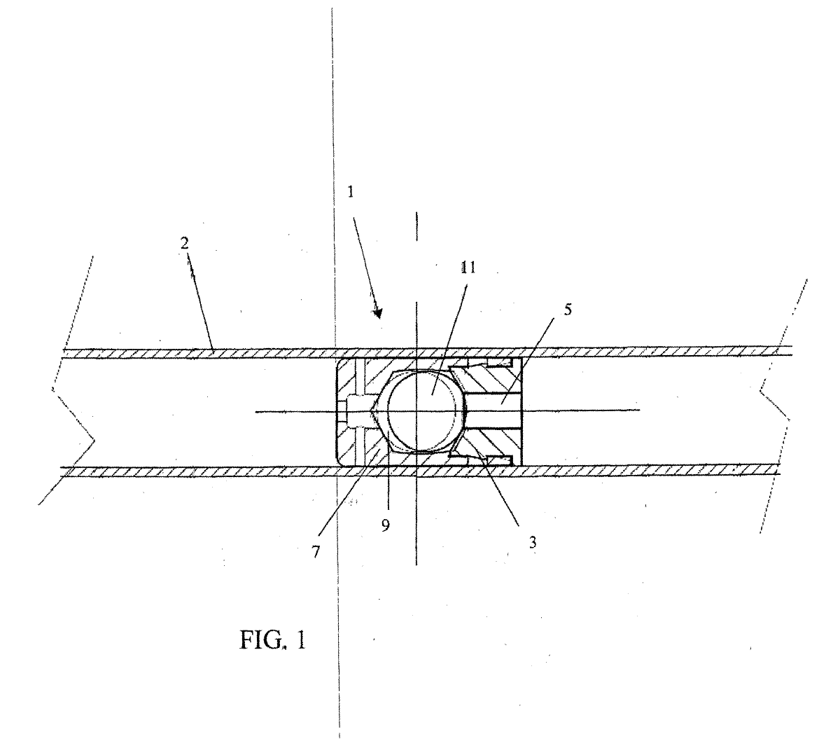

With reference to FIG. 1, there is shown a site of application of the inventive device to multifunctional valve. In this Figure, the reference signs represent the following:

\textcircled{S} Splashing water Slope—Water pressure hygroscopic \textcircled{H} Effect of Humidity \textcircled{SR}] a Humidity rain due to chemical factors \textcircled{K} condensing \textcircled{B} humidity due to construction \textcircled{SW} Water Filter lateral \textcircled{E} infiltration of moisture \textcircled{I} damage to plants \textcircled{G} Humidity geological or environmental \textcircled{A} humidity rising from the ground [symbol] Area on which the inventive device to multifunctional valve has a full effect

1. Capillary Humidity Rising from the Land \textcircled{A}

[symbol]

If the insulation (horizontal) is missing or defective conventional porous building materials absorb humidity, coming from the ground, contrary to the force of gravity, through the capillary system, in which situation it is essential to apply the inventive device to multifunctional valve for the expulsion of humidity in quantities necessary.

2A. Hygroscopic Moisture \textcircled{H}

Each every wall plaster contain, after drying, a certain amount of hygroscopic salts (which attract moisture) of its wall building structure but also salts extraneous to it (for example the salts of the ground). Due to the continuous capillary rise of moisture, these salts protrude from the wall and from the land up to settle in the area of evaporation on the plaster or on painting. After a drying of the internal walls successful, plaster or on painting remain residues of salts capable of absorbing only a certain amount of moisture in the air: there is therefore the possibility that the wall dries within but that the plaster or paint with excessive levels of salts remain moist and here it becomes indispensable for the integration of the inventive device to multifunctional valve for advantageously constant expulsion of moisture to the outside.

2B. Residual Moisture—Degree of Humidity of the Walls

[symbol]

Of course, the purpose of drying the damp walls is not to eliminate all moisture from the walls. A wall completely dry but also impossible to obtain, it would be contrary to every comfort. Advantageously, the inventive device to multifunctional valve advantageously regulates the microclimate of an environment ensuring the comfort, ejecting the ‘excess moisture’ in a natural way. Each type of masonry and every kind of building material has a degree of residual moisture natural. According to the situations, the temperatures and the use of the housing there are optimal residual moisture to reach. This matter is so important and delicate that some countries, such as Austria and Germany, have issued specific Normative for specific sector, which describe various humidity levels to be achieved, in fact, the inventive device of valves multifunction for expelling moisture advantageously meets every legislation even more restrictive.

For example, a classic brick building is totally saturated, e.g totally moist, when 25% of its weight consists of water (approximately 500 liters of water per cubic meter of the ‘building block). In this way the conventional brick is water to 100%. So the maximum residual moisture is established has then when 5% of the weight of the brick consists of water (this percentage is then obtained from 20% of 25%=5%). Also integrated into the brick inventive device a valve multifunctional for expelling moisture, advantageously provides the ‘expulsion of’ excess moisture and allows perspiration.

3. Lateral Infiltration of Moisture \textcircled{E}

[symbol]

In the presence for damage or defects in the insulation vertical (eg consider the outer walls of a cellar, which are usually in contact with the ground), moisture can penetrate laterally through the capillaries until you cross the entire core wall.

More often, it is the wall and the lower the humidity infiltration by side, the better the results of expulsion of excess moisture through for the device valve multi-function of invention. To have a house or building structure completely dry (inside and sideways), you can use various devices of the invention advantageously placed in quantity needed, obtained by appropriate calculations to determine the exact dumping moisture.

4. Water a Slope with Pressure \textcircled{D}

The water that flows from a slope or a level of water in the soil temporarily high, exert a pressure on the masonry, penetrating. When it is inside the wall, the water is pushed upward through the capillary system (hydrostatic pressure): situation in which it is essential to apply the inventive device a valve multifunction for the expulsion of humidity

5. Splashing Water \textcircled{S}

The rain, bouncing on a flat surface near the outer wall (concrete slabs, road or other), it hits the base. Obvious situation in which it is essential, to apply the inventive device a valve multifunction for the expulsion of humidity.

6. Humidity Caused by Technical Faults of Construction, Damage to Installations \textcircled{I}

This moisture comes from the lack of, or inadequate protection against ingress of rainwater (damage to the roof or roofing material, inadequately sealed fireplace, lack of protective material from the surface of the roof, chimneys unused. Missing roof drainage etc.) and/or pipeline damage (damage or clogging the gutters, clogging of drains, pipes, broken pipes, etc.) situation where it is essential to implement the inventive device a valve multifunction for expelling of humidity.

7. Moisture Due to Rain \textcircled{SR}

If the rain falling directly on the walls, the moisture penetrates the plaster is not waterproof or not plastered walls in a situation where it is essential to implement the inventive device a valve multifunction for expelling of humidity.

8. Water Infiltration \textcircled{SW}

Surface waters that are formed due to the precipitation can penetrate freely into the gaps between the ground and the wall of the building envelope, so the walls below ground level (such as those of the cellars) often become very damp: the situation in which it is essential apply the inventive device a valve multifunction for the expulsion of humidity.

9. Moisture Due to Construction, Humidity Caused by the New Plaster \textcircled{B}

The humidity is moisture construction remains “incorporated” into the wall or building structure when it is usually built in traditional materials such as brick, concrete block, etc. It evaporates slowly over about a year and a half or three years. In a recently plastered wall, the natural evaporation of the specific humidity of the plaster occurs in 1 or 2 years, and depends on the material and its thickness of the plaster. The complete process of drying of the plaster walls and instead can take place in a period of time greater than that reported for the two cases separately: the situation in which it is essential to apply the inventive device a valve multifunction for the expulsion and evaporation of humidity, in times rapid to obtain a building structure before wetness.

10. Humidity Caused by Disturbances Geological or Technical \textcircled{G}

[symbol]

Certain electromagnetic fields, electrostatic and/or other fields of different nature, brick, and concrete block and by their very nature, can increase the humidity in the capillary core wall.

There are two types of disturbances:

Geological factors: are formed due to the presence of sources of water in the subsoil, underground streams that flow quickly, tectonic fractures, etc.;

Disturbing Factors Technical transmitters are caused by television, radio, radar, cell-phones or other types of transmitters (producing the so-called “electro-smog” as certain preventive measures can reduce these waves), by electric conductors or insulated metal (pipes etc.) or by supports of lightning rods not isolated.

Even in this case the device valve multi-function invention plays a fundamental role in water evacuation and vapor diffusion.

11. Humidity Condensation \textcircled{K}

[symbol]

The warm, moist air condenses on cooler wall surfaces. This creates the moisture from condensation. The causes are often due to a faulty thermal insulation due to thin outer walls (they create a bridge cold-hot), excessive humidity in the rooms (eg bathroom, bedroom, kitchen, laundry room, or rooms where there are aquariums many plants, etc.). Airtight windows that do not allow moist air to escape, no ventilation, heating defective organic paint (emulsion paint), which is a breeding ground for mold, [symbol] damp walls (which in winter cools faster than dry): situation in which it is essential to implement the inventive device a valve multifunction for expelling of humidity.

12. Humidity Caused by Chemical Factors \textcircled{C}

The different building materials have different chemical characteristics and quality. An example is the old wall that is slightly acidic and the cement plasters which are strongly alkaline (pH values=different). These effects cause a chemical transport of humidity electrochemical wall that attracts other humidity and/or maintain high humidity. Rusty materials (steel pipes, iron frames etc.). Have a similar effect on the moisture in the walls. A complete drying of the walls is only possible situation where it is essential to implement the inventive device a valve multifunction for expelling of humidity.

There is a specific cycle to block the infiltration of rising damp. The walls of the old buildings are often subject to ingress of moisture from the ground up. At the origin of the phenomenon is the porosity of the construction materials, which determines the capacity of the material to absorb water and to transport it to rising damp.

The action of water on the masonry involves a whole series of harmful consequences which manifests itself in the form of spots of humidity on the walls, efflorescence of water-soluble salts and then prejudicial to the building structure, friability of the bricks making up the wall, chalking of the material junction and plaster, flaking and detachment of parts of the coating mural, development of sponginess in the wall and the wooden parts used for the construction, proliferation of molds and microorganisms.

The most effective way to combat the phenomenon of rising damp is to use some devices to multifunction valve of the present invention, for the evacuation of water and steam.

The process consists essentially in the introduction of some inventive device a valve multifunction by injection through holes in the masonry inclined channeled downwards, by natural gravity or better under pressure.

The problem of condensation of water vapor in building structures in its all partitions and closures transparent specimen (windows, doors) that make up the entire building envelope, whether it takes place on the surfaces of structures, whether it takes place within the same, is a risk in two ways: one linked to the preservation of buildings and that related to health environments.

It is rare to come across in the formation of mold, or watch the disintegration of plaster and building envelope precisely because of these phenomena. In relatively recent years, the need to contain the heat loss has favored the adoption of indiscriminate frames endowed with excellent air tightness that, in the absence of mechanical ventilation, however, has resulted in a significant reduction of the natural ventilation with consequent additional burden of the problem under examination caused by the moisture present in ambient air.

It is then very widespread use in kitchens of filtering hoods, with no connections to ducts of the fumes expulsion, that the advantage of the compositional freedom of the kitchen furnishing contrast the disadvantage of placing large quantities of steam in the environment as a result the cooking of food.

The formation of condensation, a phenomenon typical of poorly insulated structures (thermal bridging), can also occur even in the presence of well-isolated structures where, however, the placement of the insulating layer, is misplaced with respect to the permeability of the remaining layers.

It should also be taken not to confuse condensation with those due to the presence of water infiltrations, for example for capillary rise from the ground, to driving rain, for breaking water pipe, etc.

As stated above, you can see the complexity of dealing with the phenomenon, the resolution of which depends, however, on the exact understanding of the causes which determine, it.

Said inventive device valve multifunctional inserted in all partitions and closures transparent specimen (windows doors), that make up the entire building envelope super insulate, exclusively and advantageously solves the aforementioned problems and known allowing a perfect breathability without energy consumption thanks to its special shape more later described.

As can be noted from the treatment of mixtures of dry air and water vapor, the condensation of water vapor occurs when the partial pressure of the same reaches the saturation pressure, the latter a function of temperature (condensation temperature or dew); at the same temperature, the higher the content of steam, and therefore the higher the relative humidity, the greater the risk of condensation (the condensation can occur even in the presence of modest cooling ambient air).

In order to verify the occurrence or not of the condensate must therefore always check that the temperature, surface and/or internal to the wall and in all partitions and closures transparent specimen (windows doors) that make up the entire building envelope, is greater than the relative condensing temperature (e.g the partial pressure of steam is greater than the saturation pressure). In the specific case, the analysis of the physical phenomenon relates to the molecular diffusion of a gas (water vapor) in a solid and is expressible by the Fick's law; simplifications deriving there from, together with the can consider the vapor water a perfect gas, mean that the determination of the flow of steam that spreads inside a solid, it may be expressed in terms of the pressure gradient that occurs due to variations in temperature and therefore the density (or other terms to vary the concentration of water vapor in the air); the treatment of the problem then becomes quite similar from the point of view of physical and analytical to what was seen for the transmission of heat. The new physical parameter that characterizes the components is then the vapor permeability or diffusivity, which is a coefficient that represents the amount of steam that passes per unit time through a unit thickness of the material, due to a difference unitary pressure.

Oftentimes in the literature values of the resistance to the flow of steam are expressed in dimensionless form by means of the parameter P, given by the ratio between the resistance to the flow of vapor of the material under examination and the reference assumed equal to the resistance to vapor diffusion to offer air for the same thickness; course for the air that is μ=1.

For example, a resistance μ=10 of a brickwork filled devoid of plaster, means that the test material has a permeability value less than that of air; convenience in the adoption of the values p aforesaid, having to dealing with very small values of the permeability, is in the greater simplicity in calculations, and then in the lower risk of committing errors with the units of measurement.

As regards the surface resistances to the passage of vapor, they can be held completely negligible compared to the resistance offered by the other building components, therefore the partial pressure of the steam on the inner and outer faces of the component are assumed equal to the partial pressure of the vapor of air contacting surface.

The flow of steam takes place when you create a pressure differential; the direction of the flow goes from the warmer environment to the colder ones (the higher vapor content of the first corresponds to a higher pressure), and then generally occurs from the inside to the external environments in both summer and winter.

In general, it is noted that the internal condensation does not take place in the walls homogeneous, but in those multilayer. In particular it is noted that if the layer facing the warm environment is richer in water vapor has a higher thermal conductivity, in which case the partial pressure of water vapor (PV) reaches high values in the areas of the wall that (a due to the low thermal resistance) are located at relatively low temperatures and accordingly with values of the saturation pressure (PS) modest: these areas are considered therefore at high risk of condensation (PV−PS).

The problem, as will be seen, can be addressed by providing an insulating layer towards the cold side (thermal coat-external thermal insulation), thus raising the temperature value and then the saturation pressure: situation in which it is essential to integrate the inventive device in quantities necessary for the expulsion of moisture.

To assess the risk of condensation you can take the road through analytical Fick's law (Fick's first law relates the diffusive flux to the concentration under the assumption of steady state) determining the amount of vapor may be condensed, or you can solve the problem graphically using the Glaser diagram (The Glaser diagram is a graphical method that allows the study of the phenomenon of condensation inside a wall consisting of one or more layers, normally used in civil engineering), this diagram is to represent together with the trend in temperature inside the building structure—building envelope, but also the corresponding values of the saturation pressure; comparing the latter with the values of the partial pressures is able to determine the application of the inventive device to avoid any risk of condensation.

The above and other objects and advantages of the invention, as will appear from the following description, are achieved with a device in multi-function valve for expulsion of humidity, saturated steam and breathability for building structures such as the one described in claim 1.

Preferred embodiments and non trivial variations of the present invention are the subject of the dependent claims.

It is understood that all appended claims form an integral part of the present description.

The present invention will be better described by some preferred embodiments, given as an example and not limitative, with reference to the accompanying drawings, in which:

FIG. 1 is a partial side sectional view of an installation of the device of the present invention;

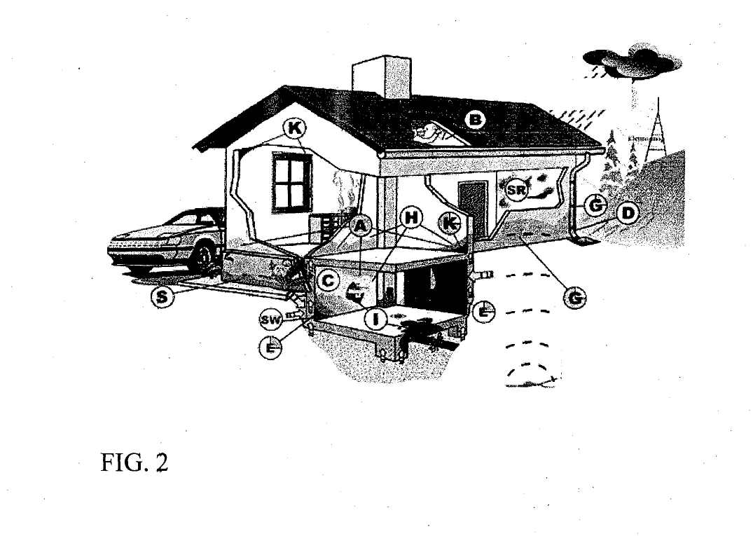

FIG. 2 illustrates schematically a possible field of application of the device of the present invention;

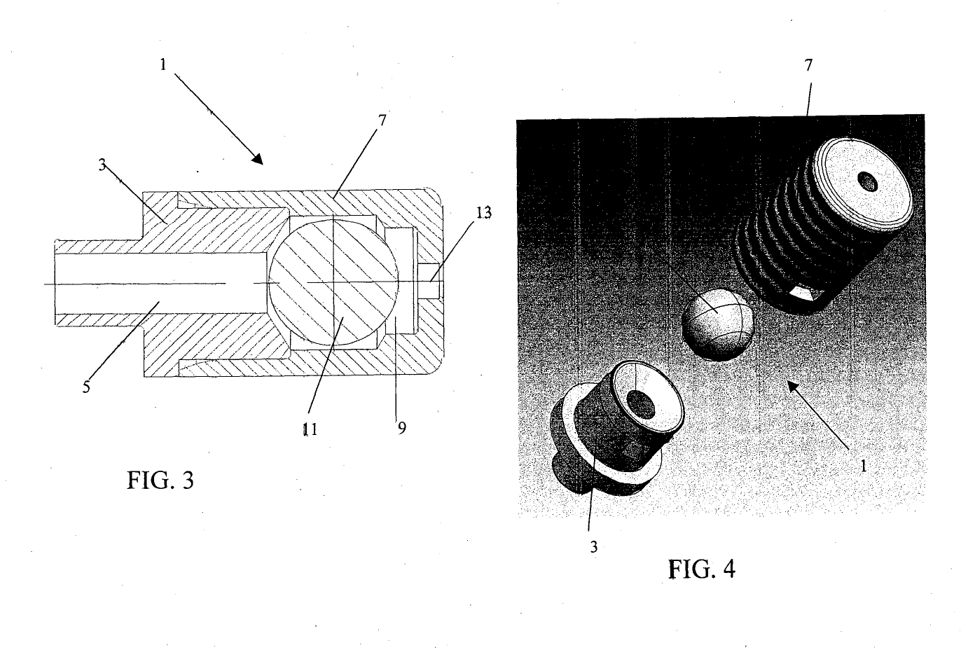

FIGS. 3 and 4 are respectively a side view in cross section and an perspective exploded view of a first preferred embodiment of the device of the present invention;

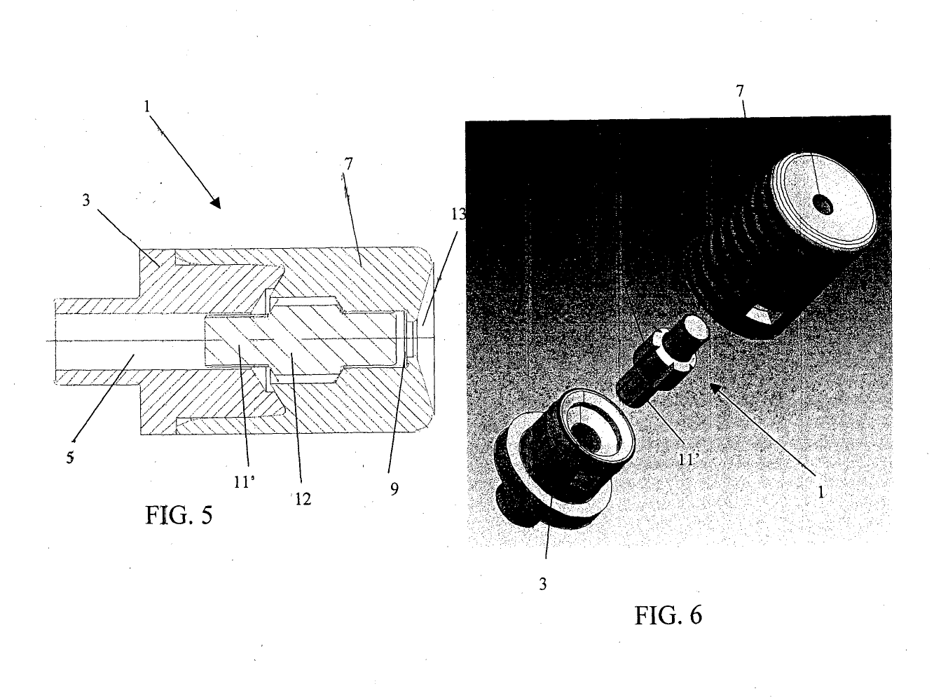

FIGS. 5 and 6 are respectively a side view in cross section and an perspective exploded view of a second preferred embodiment of the device of the present invention;

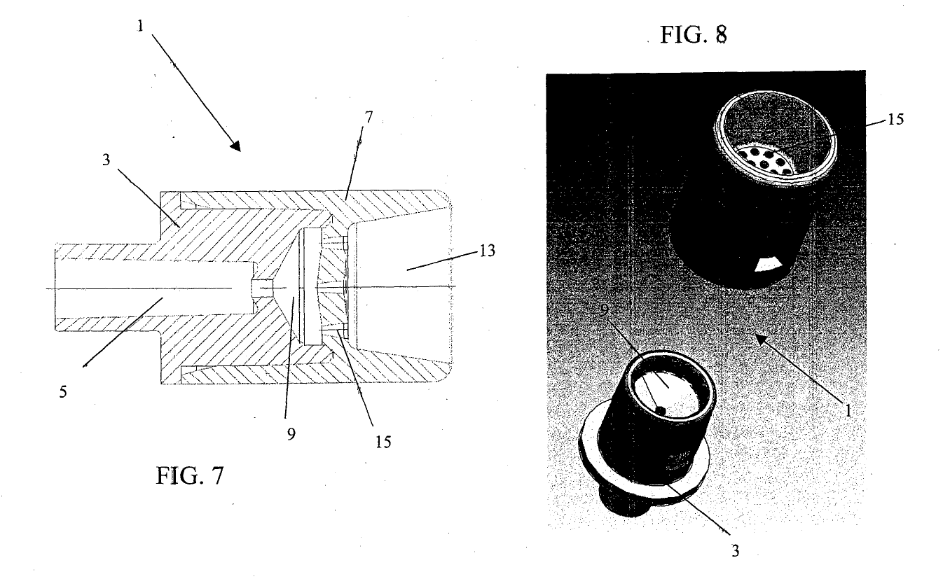

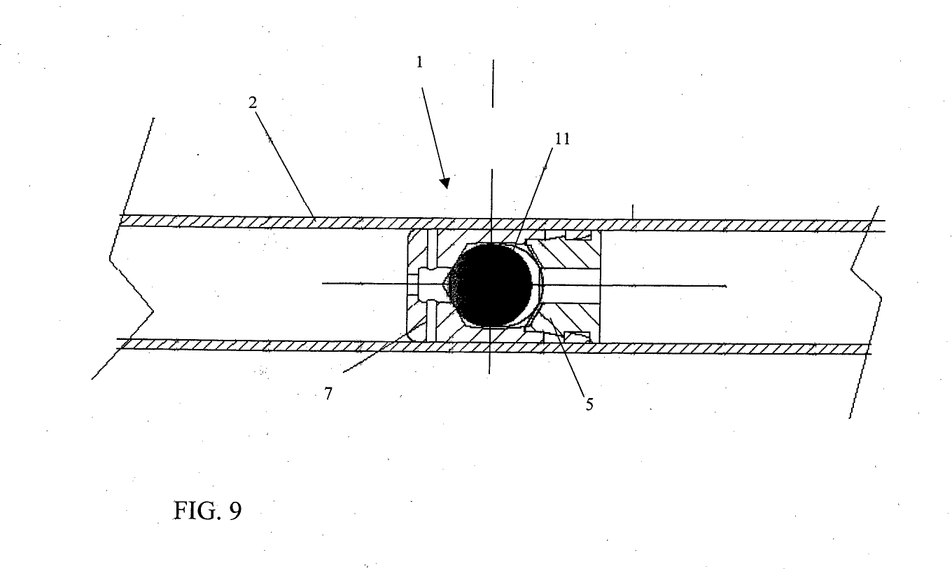

FIGS. 7 and 8 are respectively a side view in cross section and an perspective exploded view of a third preferred embodiment of the device of the present invention; and

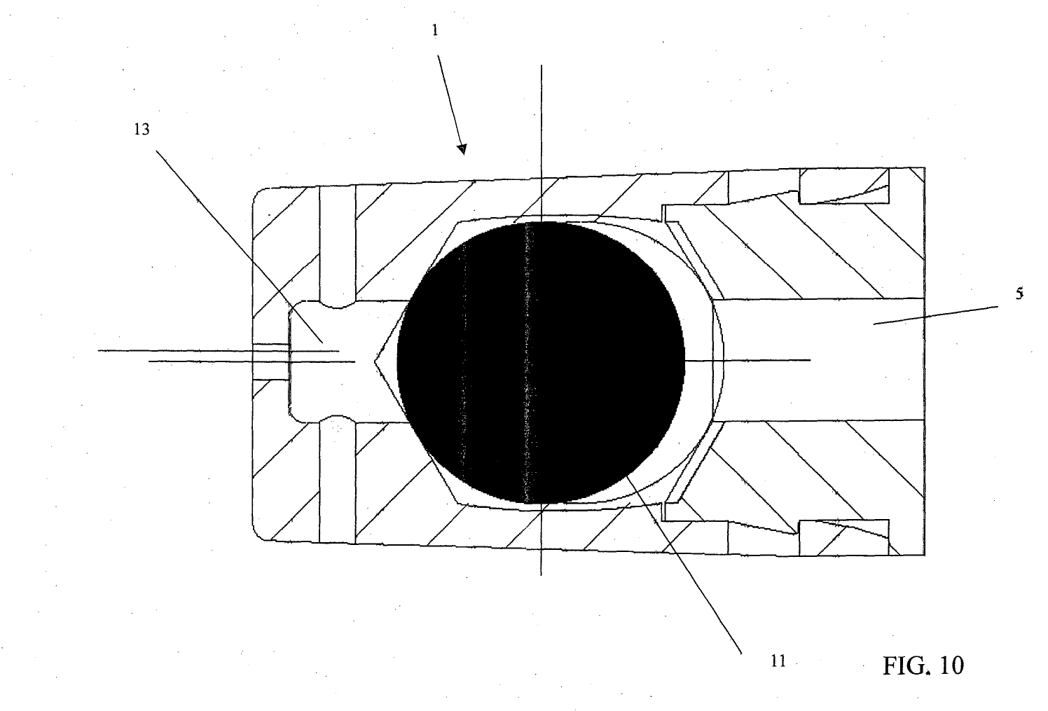

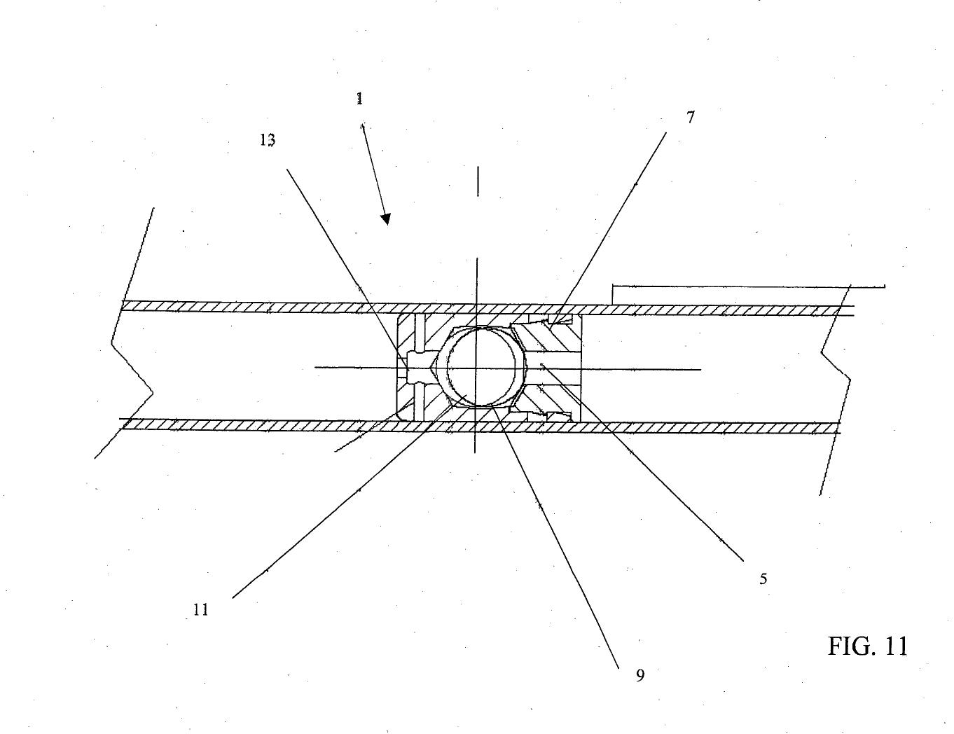

FIGS. 9 to 13 are view of other preferred, but not limiting, embodiments of the inventive valve, in as many preferred, but not limiting, applications.

Referring to FIGS. 1 and 3 to 8, are shown and described various preferred embodiment, but not limiting, of the device in multi-function valve for expulsion of moisture and saturated steam for building structures of the present invention. Be immediately obvious that it will be possible to make what is described numerous variations and modifications (for example related to shape, sizes, arrangements and parts with equivalent functionality) without departing from the scope of the invention as appears from the attached claims.

As illustrated, the device 1 to multi-function valve allows the expulsion of moisture and saturated vapor by exploiting the difference in pressure existing inside of the ducts 2, or the like, in building structures in all its partitions' and elements that compose it as doors and windows etc.; for this purpose, the device 1 comprises essentially:
At least a first sealing element 3 provided with a first conduit cable 5 for communication with the atmosphere the outside of device 1;
At least one second sealing element 7 operatively coupled, to the first sealing element 3 and provided with a head containment receptacle 9, wherein the second sealing element 7 is further equipped with a second conduit cable 13 for. Communication with the atmosphere to ‘exterior of the device. 1; and
At least one element of opening/closure member 11, 11, 15 of the device 1, which element of opening/closure member 11, 15 is adapted to assume a closed position of the device 1 in which it is in, contact with the first sealing element 3 (FIG. 1) closing the first hollow duct 5, and is also adapted to assume an open position of the device in which it is not in contact with the first sealing element 3 (FIGS. 3 and 4) and puts in communication the first hollow duct 5 and the second conduit cable 13, and therefore allows you to download humidity and saturated vapor in the atmosphere outside the device 1 when the pressure inside the building structure causes the thrust, element opening in the opening/closure 11, 11, 15.

In particular, the element for opening/closure member 11, 11, 15 can be formed, preferably but not exclusively, by at least one ball element 11 (FIGS. 1, 3 and 4), or by at least one elongated cylindrical element 11’ provided with at least a central, annular enlargement 12 with some grooves (FIGS. 5 and 6).

According to a third preferred embodiment, also not limitative, illustrated in FIGS. 7 and 8, the element of opening/closure member 11, 11, 15 can be constituted by at least one tiny hole 15 (and preferably a plurality of small holes 15, as illustrated) of longitudinal section progressively increasing from the first hollow duct 5 and the seat 9 and end up in the second conduit cable 13, in order to exploit a Venturi effect for the opening/closing of the device 1: in this case, in fact, only in the presence of elevated pressure is able to overcome the resistance of the inlet section of the holes 15 to the passage of the flow of air containing moisture and saturated steam, in a manner equivalent to an open operation of the device 1. If the pressure is not high enough, the small section of entry will prevent the outflow of air, operating substantially as closing element of the device 1 of the invention.

According to a variation, not shown, moreover, the inventive device 1 can further comprise a capsule equipped with self-heating filaments connected to an external plant for reducing the voltage to heat the framework in which the device 1 is housed.

Moreover, the multi-functional valve device 1 of the invention can be individually applied in all manufactured building products, such as frames, doors, windows, bricks, block inside the ICF connectors and/or spacers and everything that is an integral part of the whole, exclusively transpiring building envelope.

In one embodiment, the multi-functional valve of the present invention comprises a conductor that conducts the condensed water to a recipient allowing reuse of the same.

In one embodiment, the multi-functional valve device of the present invention comprises at least one activated carbon filter to filter the condensed water making it potable.

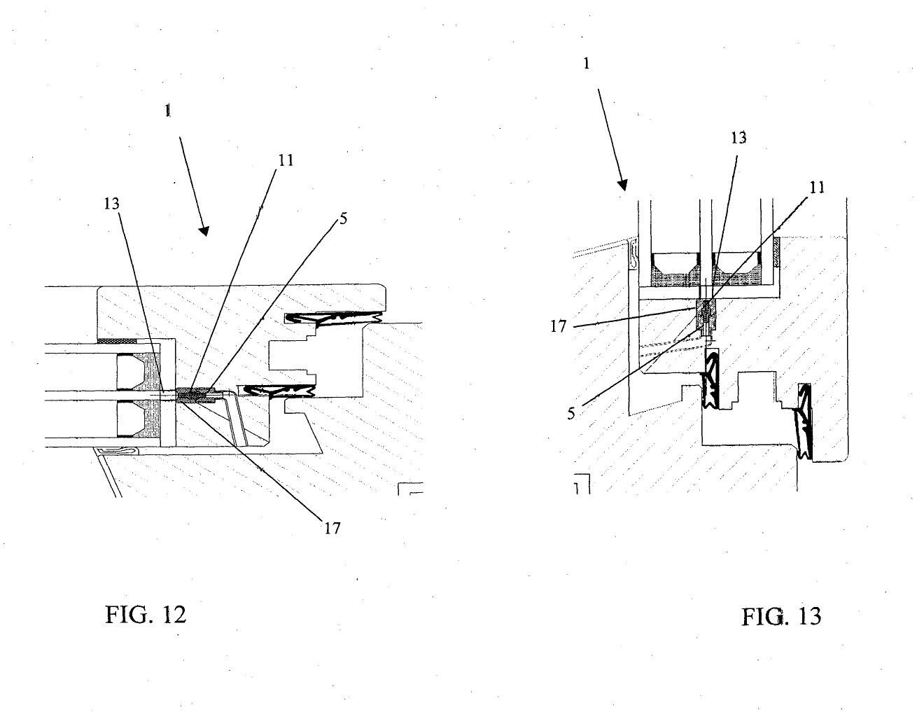

In one embodiment, the multi-functional valve of the present invention when installed into a frame of the window and/or door or inside the double or triple glazing (FIGS. 12 and 13) advantageously eliminates moisture turning it into water by the natural process of temperature difference but at the same time, using a channeling formed, allows it to breathe in the internal environment of the building envelope, thus avoiding to open the windows for a replacement of air. This brings the advantage of eliminating smog and of course the sounds that ensue if you live in cities with high population density as, for example, in CHINA.

1. Multi-functional valve device (1) for expelling humidity and saturated steam, characterized in that it is adapted to operate through small pressure difference existing inside building structures and outside of it wherein it is adapted to be placed in building structure, said device (1) comprising:
at least one first holding element (3) equipped with a first hollow duct (5) for communicating with the interior of the building structure;
at least one second holding element (7) operatively coupled with the first holding element (3) and equipped with a containing seat (9), said second holding element (7) being further equipped with a second hollow duct (13) for communicating with outside of the building structure; and
at least one opening/closing element (11, 11′, 15) of the device (1), said opening/closing element (11, 11′, 15) being adapted to assume a closing position of the device (1) in which it is in contact with the first holding element (3) closing the first hollow duct (5), said opening/closing element (11, 11′, 15) being adapted to also assume an opening position of the device (1) in which it is not in contact with the first holding element (3) and communicates the first hollow duct (5) and the second hollow duct (13).

2. Device (1) according to claim 1, characterised in that the opening/closing element (11, 11′, 15) is composed of at least one ball-shaped element (11).

3. Device (1) according to claim 1, characterised in that the opening/closing element (11, 11′, 15) is composed of at least one elongated cylindrical element (11′) equipped with at least one central annular enlargement with grooves (12).

4. Device (1) according ‘to claim 1, characterised in that the opening/closing element (11, 11′, 15) is composed of at least one small hole (15) with a progressively increasing longitudinal section starting from said first hollow duct (5) and said seat (9) and ending in said second hollow duct (13) in order to exploit a Venturi effect for opening/closing the device (1).

5. Device (1) according to claim 1, characterised in that said opening/closing element (11, 11′, 15) is made of phenolic resin or resin coated with nitryl rubber resisting to clean, soft or sea waters, to flowing or rain waters, also with hydrocarbon residuals.

6. Device (1) according to claim 1, characterised in that it further comprises a capsule equipped with self-heating filaments connected to an external plant for reducing the voltage—to heat the framework, windows, doors in which the device (1) is housed.

7. Device (1), according to claim 1, characterized in that the building structure comprises all manufactured building products, such as foundations, floors, roofs, walls, frames, doors, windows, bricks, ICF connectors and/or spacers, recesses and everything that is an integral part of the whole, exclusively transpiring building envelope.

8. Device (1), according to claim 7, characterized by the fact that the manufactured building product is coated with thermal coating.

9. Device (1), according to claims 1-8, characterized it can be used in a vertical, horizontal or inclined position.

10. Device (1), according to claims 1-9, characterized by evacuate the moisture, saturated steam and intersticial condensation of building envelope.

11. Device (1), according to claims 1 and 7 characterized in that the building structure is monohlithic or hollow.

12. Device (1), according to claims 1 to 11, characterized in that comprises at least one activated carbon filter to filter the condensed water making it potable.

13. Device (1), according to claims 1 to 12, characterized in that comprises a conductor that conducts the condensed water to a recipient.

14. Process of remotion of moisture, saturated steam and intersticial condensation of buildings characterized by installing in a building structure a multi-functional valve device comprising:
at least one first holding element (3) equipped with a first hollow duct (5) for communicating with the interior of the building structure;
at least one second holding element (7) operatively coupled with the first holding element (3) and equipped with a containing seat (9), said second holding element (7) being further equipped with a second hollow duct (13) for communicating with outside of the building structure; and
at least one opening/closing element (11, 11′, 15) of the device (1), said opening/closing element (11, 11′, 15) being adapted to assume a closing position of the device (1) in which it is in contact with the first holding element (3) closing the first hollow duct (5), said opening/closing element (11, 11′, 15) being adapted to also assume an opening position of the device (1) in which it is not in contact with the first holding element (3) and communicates the first hollow duct (5) and the second hollow duct.

15. Process, according to claim 14, characterized by the opening/closing element(11, 11′, 15) be a ball-shaped element (11).

16. Process, according to claim 14, characterized by the opening/closing element be one elongated cylindrical element (11′) equipped with at least one central annular enlargement with grooves.

17. Process, according to claims 14-16, characterised in that said opening/closing element (11, 11′, 15) is made of phenolic resin or resin coated with nitryl rubber resisting to clean, soft or sea waters, to flowing or rain waters, also with hydrocarbon residuals.

18. Use of a multi-functional valve device as described in claims 1 to 13 characterized for being installed into a frame of the window and/or door or inside the double or triple glazing.

19. Use, according to claim 18, characterized for forming a permanent channel eliminating the necessity of open the window or door for changing air at the same time that eliminates external noise.
